(19) United States
(12) Patent Application Publication
(10) Pub. No.: US 2010/0137083 A1
(43) Pub. Date: Jun. 3, 2010

(54) VEHICLE MACHINE CONTROLLED BELT TENSION SYSTEM AND METHOD TO CONTROL BELT TENSION

(76) Inventor: J. DAVID CARLSON, Cary, NC (US)

Correspondence Address: LORD CORPORATION;PATENT & LEGAL SERVICES, 111 LORD DRIVE, P.O. Box 8012, CARY, NC, 27512-8012, US

(21) Appl. No.: 12/507,170

(22) Filed: Jul. 22, 2009

Related U.S. Application Data
(60) Provisional application No. 61/082,668, filed on Jul. 22, 2008.

(51) Int. Cl. F16H 7/08

(52) U.S. Cl. 474/110

(57) ABSTRACT

A vehicle machine with a belt system and a belt. The belt system includes a tensioner with a tensioner moving member which is movably supported on a tensioner stationary member; a tensioner pulley which is rotatably supported on the tensioner moving member and around which at least a portion of the belt is engaged. The belt system includes a bias member, the bias member biasing the tensioner moving member with the tensioner pulley pressing the belt. The belt system includes a controllable electrical current supply and an electromagnetic brake lock, the electromagnetic brake lock including a brake lock electromagnetic coil and a brake lock magnetic target, the electromagnetic brake lock disposed between the tensioner moving member and the tensioner stationary member wherein a controlled current supplied from the controllable electrical current supply to the brake lock electromagnetic coil inhibits the tensioner moving member from moving relative to the tensioner stationary member.

### CROSS REFERENCE

This application claims the benefit of, and incorporates by reference, U.S. Provisional Patent Application No. 61/082,668 filed Jul. 22, 2008.

### FIELD OF THE INVENTION

The invention relates to the field of vehicles and machines with belts. The invention relates to the field of belt tension systems. More particularly the invention relates to the field of controlled belt tension systems and methods of controlling belt tension.

### SUMMARY OF THE INVENTION

In an embodiment the invention includes a vehicle. The vehicle includes a motor engine and a belt system with a belt.

In an embodiment the tensioner is used in a belt drive system for a internal combustion engine combined with an electric alternator to generate electricity, preferably a Belt Alternator Starter (BAS) system, with a lower fuel efficiency operation mode increased fuel economy by shutting off the engine when at an idle operating mode, and enabling early fuel cut-off during decelerations, and preferably with regenerative braking. Preferably the BAS system combines engine controls with a combined alternator/starter motor mounted with respect to the engine in an accessory drive position. Preferably the automotive accessory drive system includes a drive pulley connected to an output of the engine. Preferably a drive belt engages an engine output pulley, with the belt wrapped and engaging multiple driven pulleys. The flexible belt transmits forces between the output pulley and the driven pulleys. The driven pulleys are attached to vehicle devices such as a power steering units, air conditioning units, and pumps. Also preferably at least one driven pulley is an idler pulley which is used to assist the orientation, routing, and/or tensioning of the belt. Preferably the BAS system includes a combined starter/alternator motor mounted with respect to the other components of the belt drive system, the BAS system starter/alternator motor restarts the engine, with the driven pulley linked with the engine's output shaft mounted drive pulley by the drive belt, the belt having a tension side and slack side while the engine is running. Preferably the tensioner is disposed to maintain tension on the slack side of the flexible drive belt. Preferably when a vehicle operation controller request controls a switching of operation mode to restart the engine, the driven pulley mounted to the combined alternator/starter motor will impart the rotational force to start the engine through the belt to the output shaft of the engine, with the normal slack side of the drive belt becoming the tension side during such BAS engine restart, and preferably to maintain the required frictional force between the flexible drive belt and the drive and driven pulleys during restart, the tensioner brake lock is locked to maintain the controlled belt tension.

In an embodiment the invention includes a belt tensioner for a belt. The belt tensioner comprising a tensioner moving member movably supported on a tensioner stationary member; with a tensioner rotating engagement member idler pulley which is rotatably supported on the tensioner moving member, the tensioner pulley for engaging the belt. Preferably the belt tensioner includes a bias member, the bias member biasing the tensioner moving member with the biased tensioner moving member tensioner pulley pressing the belt to tension the belt. The belt tensioner includes an electromagnetic brake lock, the electromagnetic brake lock including a brake lock electromagnetic coil and a brake lock magnetic target, the electromagnetic brake lock disposed between the tensioner moving member and the tensioner stationary member wherein a controlled current supplied to the brake lock electromagnetic coil inhibits the tensioner moving member from moving relative to the tensioner stationary member.

In an embodiment the invention includes a belt tensioner electromagnetic brake lock for controlling a tension of a belt with a controllable belt tension electrical current supply. The belt tensioner electromagnetic brake lock comprises a tensioner stationary member brake lock electromagnetic coil and a tensioner moving member brake lock magnetic rotating target, wherein a controlled current supplied to the tensioner stationary member brake lock electromagnetic coil inhibits the tensioner moving member brake lock magnetic rotating target from moving relative to the tensioner stationary member brake lock electromagnetic coil and controls the tension of the belt.

In an embodiment the invention includes a method of controlling vehicle machine belt motion of a machine. The method includes providing a machine with a belt system with a belt.

In an embodiment the invention includes a method of making a belt tensioner for tensioning a belt with a controlled current from a controllable electrical current supply.

In an embodiment the invention includes a machine. The machine including a belt system with a belt.

It is to be understood that both the foregoing general description and the following detailed description are exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principals and operation of the invention.

### BRIEF DESCRIPTION OF THE DRAWINGS

FIG. 1 illustrates a vehicle machine automotive drive belt system with an electromagnetic brake lock band-brake controlled belt tensioner.

FIG. 2 illustrates an electromagnetic brake lock band-brake coupled with a torsion spring belt tensioning device.

FIG. 3 illustrates an electromagnetic brake lock band-brake coupled with a clock spring belt tensioning device.

FIG. 4 illustrates a torsion clock spring.

FIG. 5 illustrates an electromagnetic brake lock band attached to a housing with a tab-in-slot connection.

FIG. 6 illustrates an electromagnetic brake lock band attached to a housing with a hard connection such as a rivet or weld.

FIG. 7 illustrates an electromagnetic brake lock band-brake tensioner with a torsion spring bias member and a damping element member damping relative rotation movement even when current is not applied to the electromagnetic brake lock coil to draw the brake lock band inward into contact with the poles.

FIG. 8 illustrates an electromagnetic brake lock band-brake tensioner with a clock spring bias member and torsion damping elastomeric damping friction element seal.

FIG. 9 illustrates a vehicle machine with an engine, belt system and an electromagnetic brake lock band-brake tensioner.

FIG. 10 illustrates a vehicle engine and belt system and an electromagnetic brake lock band-brake tensioner.

FIG. 11 illustrates an electromagnetic brake lock band-brake tensioner is a target locking state with a supplied current electromagnetically attracting and drawing the rotating housing band inward into contact with the fixed stationary member removing the gap there between.

### DETAILED DESCRIPTION OF THE PREFERRED EMBODIMENT

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

Reference will now be made in detail to the present preferred embodiments of the invention, examples of which are illustrated in the accompanying drawings.

In an embodiment the invention includes a vehicle. The vehicle includes an engine motor and a belt system with a belt.

The belt system including a tensioner with a tensioner moving member which is movably supported on a tensioner stationary member. The tensioner preferably includes a tensioner rotating engagement member pulley which is rotatably supported on the tensioner moving member and around which at least a portion of the belt is engaged.

The vehicle belt system includes a bias member, the bias member biasing the tensioner moving member with the tensioner pulley pressing the belt.

The vehicle belt system includes a controllable electrical current supply.

The vehicle belt system includes an electromagnetic brake lock, the electromagnetic brake lock including a brake lock electromagnetic coil and a brake lock magnetic target, the electromagnetic brake lock disposed between the tensioner moving member and the tensioner stationary member wherein a controlled current supplied from the controllable electrical current supply to the brake lock electromagnetic coil inhibits the tensioner moving member from moving relative to the tensioner stationary member.

Preferably the vehicle has a plurality of operation modes including at least a first operation mode and at least a second operation mode, and the vehicle includes a controller, the controller controlling a change from the at least first operation mode to the at least second operation mode, wherein the controlled current is supplied to the brake lock electromagnetic coil at least during the change from the at least first operation mode to the at least second operation mode, preferably to lock the movable member and contain the tension in the belt. Preferably the change in operation modes are an energy efficiency change of the vehicle, with the vehicle controller changing the vehicle and the engine between energy efficiency modes, preferably in an effort to conserve energy.

Preferably the vehicle has a plurality of operation modes including at least a first lower fuel efficiency operation mode and at least a second higher fuel efficiency operation mode, and the vehicle includes a controller, the controller controlling a change from the at least first low efficiency operation mode to the at least second high efficiency operation mode, wherein the controlled current is supplied to the brake lock electromagnetic coil at least during the change from the at least first low fuel efficiency operation mode to the at least second high fuel efficiency operation mode, preferably while the vehicle remains in the at least second high fuel efficiency operation mode, preferably to lock the movable member and contain the tension in the belt. In an embodiment the tensioner is used in a belt drive system for a multicylinder engine provided with a cylinder suspension controller which suspends the operation of some cylinders in the engine in the at least second high fuel efficiency operation mode operation, preferably with the vehicle and belt system including a magnetic force controller which controls the magnetic force such that the magnetic force is applied to the target in response to a signal from the cylinder suspension controller which is given when the operation of the cylinders is suspended (higher fuel efficiency) or the operation of the suspended cylinders is restarted by the cylinder suspension controller, operation of the multicylinder engine is shifted from a full cylinder operation mode (lower fuel efficiency) in which all of the cylinders are working to a partial cylinder operation mode (higher fuel efficiency) in which not less than one third thereof are suspended from working, the magnetic force is applied to the target in synchronization with the change in the number of the working cylinders.

In an embodiment the tensioner is used in a belt drive system for a internal combustion engine combined with an electric alternator to generate electricity, preferably a Belt Alternator Starter (BAS) system, with a lower fuel efficiency operation mode increased fuel economy by shutting off the engine when at an idle operating mode, and enabling early fuel cut-off during decelerations, and preferably with regenerative braking. Preferably the BAS system combines engine controls with a combined alternator/starter motor mounted with respect to the engine in an accessory drive position. Preferably the automotive accessory drive system includes a drive pulley connected to an output of the engine. Preferably a drive belt engages an engine output pulley, with the belt wrapped and engaging multiple driven pulleys. The flexible belt transmits forces between the output pulley and the driven pulleys. The driven pulleys are attached to vehicle devices such as a power steering units, air conditioning units, and pumps. Also preferably at least one driven pulley is an idler pulley which is used to assist the orientation, routing, and/or tensioning of the belt. Preferably the BAS system includes a combined starter/alternator motor mounted with respect to the other components of the belt drive system, the BAS system starter/alternator motor restarts the engine, with the driven pulley linked with the engine's output shaft mounted drive pulley by the drive belt, the belt having a tension side and slack side while the engine is running. Preferably the tensioner is disposed to maintain tension on the slack side of the flexible drive belt. Preferably when a vehicle operation controller request controls a switching of operation mode to restart the engine, the driven pulley mounted to the combined alternator/starter motor will impart the rotational force to start the engine through the belt to the output shaft of the engine, with the normal slack side of the drive belt becoming the tension side during such BAS engine restart, and preferably to maintain the required frictional force between the flexible drive belt and the drive and driven pulleys during restart, the tensioner brake lock is locked to maintain the controlled belt tension.

Preferably the electromagnetic brake lock electromagnetic coil includes an electromagnetic core with a first north contact pole and a second south contact pole, and the electromagnetic brake lock magnetic target includes a magnetic brake band, wherein the controlled current is supplied to the brake lock electromagnetic coil to electromagnetically engage the magnetic brake band with the first north contact pole and a second south contact pole.

Preferably the controllable electrical current supply is controllable to supply a first positive direction current to the brake lock electromagnetic coil and a second negative direction current to the brake lock electromagnetic coil.

Preferably the tensioner includes a tensioner damping member, with the tensioner damping member disposed between the tensioner moving member and the tensioner stationary member. The tensioner damping member damping the dynamic motion between the tensioner moving member and the tensioner stationary member, preferably when no current is supplied to the EM coil.

Preferably the bias member comprises a spring, preferably disposed between the tensioner moving member and the tensioner stationary member, preferably a metal spring, preferably a metal wound spring such as torsion spring or a clock spring.

Preferably the magnetic target band is coupled with the torque idler arm, with the magnetic target band rotating with the rotating housing with the unlocking state target gap between the rotating target band and the stationary EM coil.

Preferably the EM coil is coupled with the tensioner stationary member, with the unlocking state target gap between the rotating target band and the stantionary EM coil, with the supplied current drawing the band inward and into physical contact and moving the target gap outward to between the now stationary target band and the rotation inhibited housing. Preferably when the controlled current is supplied, the magnetic target is drawn inward toward the EM coil, preferably with the magnetic target physically mechanically engaging an interface of the tensioner stationary member, preferably the EM coil lock poles, preferably with the magnetic target comprised of a magnetic brake band, preferably with the magnetic brake band wrapping around substantially an outer circumference of the tensioner stationary member. Preferably the magnetic brake band has at least one band end connected with the torque arm tensioner moving member housing, preferably with the one anchored end connected and the distal other end of the band unanchored and free. Preferably the electromagnetic brake lock electromagnetic coil includes a electromagnetic core with a first north contact pole and a second south contact pole, and the electromagnetic brake lock magnetic target includes a magnetic brake band, wherein the controlled current is supplied to the brake lock electromagnetic coil to electromagnetically engage the magnetic brake band with the first north contact pole and a second south contact pole.

In an embodiment the invention includes a belt tensioner for a belt. The belt tensioner comprising a tensioner moving member movably supported on a tensioner stationary member; with a tensioner rotating engagement member idler pulley which is rotatably supported on the tensioner moving member, the tensioner pulley for engaging the belt. Preferably the belt tensioner includes a bias member, the bias member biasing the tensioner moving member with the biased tensioner moving member tensioner pulley pressing the belt to tension the belt. The belt tensioner includes an electromagnetic brake lock, the electromagnetic brake lock including a brake lock electromagnetic coil and a brake lock magnetic target, the electromagnetic brake lock disposed between the tensioner moving member and the tensioner stationary member wherein a controlled current supplied to the brake lock electromagnetic coil inhibits the tensioner moving member from moving relative to the tensioner stationary member.

Preferably the tensioner moving member rotates relative to the tensioner stationary member, preferably supported with at least one bearing, with the brake lock magnetic target coupled with the tensioner moving member with the brake lock magnetic target rotating relative to the tensioner stationary member when the controlled current is not supplied.

Preferably the belt tensioner has a plurality of operation modes including at least a first operation mode and at least a second operation mode, wherein a belt tensioner controller controls a change from the at least first operation mode to the at least second operation mode, with the controlled current supplied to the brake lock electromagnetic coil at least during the change from the at least first operation mode to the at least second operation mode to lock the movable member and contain the tension in the belt, preferably for energy efficiency changes of machines between energy efficiency modes. Preferably the belt tensioner has operation modes including at least a first low fuel efficiency operation mode and at least a second high fuel efficiency operation mode, to lock the movable member and contain the tension in the belt. In an embodiment the belt tensioner is a deactivating multicylinder engine belt tensioner used in a belt drive system for a multicylinder engine provided with a cylinder suspension controller which suspends the operation of some cylinders in the engine in operation. Preferably the tensioner comprises a magnetic force controller which controls the magnetic force such that the magnetic force is applied to the target in response to a signal from the cylinder suspension controller which is given when the operation of the cylinders is suspended or the operation of the suspended cylinders is restarted by the cylinder suspension controller, operation of the multicylinder engine is shifted from a full cylinder operation mode in which all of the cylinders are working to a partial cylinder operation mode in which not less than one third thereof are suspended from working, the magnetic force is applied to the target in synchronization with the change in the number of the working cylinders. In an embodiment the belt tensioner is a Belt Alternator Starter (BAS) system engine belt tensioner for an internal combustion engine combined with an electric alternator to generate electricity, preferably Belt Alternator Starter (BAS) system, with increased fuel economy by shutting off the engine when at an idle operating mode, and enabling early fuel cut-off during decelerations, and preferably with regenerative braking. Preferably the BAS system combines engine controls with a combined alternator/starter motor mounted with respect to the engine in an accessory drive position. Preferably the automotive accessory drive system includes a drive pulley connected to an output of the engine. Preferably a drive belt engages an engine output pulley, with the belt wrapped and engaging multiple driven pulleys. The flexible belt transmits forces between the output pulley and the driven pulleys. The driven pulleys are attached to vehicle devices such as a power steering units, air conditioning units, and pumps. Also preferably at least one driven pulley is an idler pulley which is used to assist the orientation, routing, and/or tensioning of the belt.

Preferably the BAS system includes a combined starter/alternator motor mounted with respect to the other components of the belt drive system, the BAS system starter/alternator motor restarts the engine, with the driven pulley linked with the engine's output shaft mounted drive pulley by the drive belt, the belt having a tension side and slack side while the engine is running. Preferably the tensioner is disposed to maintain tension on the slack side of the flexible drive belt. Preferably when a vehicle operation controller request controls a switching of operation mode to restart the engine, the driven pulley mounted to the combined alternator/starter motor will impart the rotational force to start the engine through the belt to the output shaft of the engine, with the normal slack side of the drive belt becoming the tension side during such BAS engine restart, and preferably to maintain the required frictional force between the flexible drive belt and the drive and driven pulleys during restart, the tensioner brake lock is locked to maintain the controlled belt tension.

Preferably the electromagnetic brake lock electromagnetic coil includes an electromagnetic core with a first north contact pole and a second south contact pole, and the electromagnetic brake lock magnetic target includes a magnetic brake band, wherein the controlled current is supplied to the brake lock electromagnetic coil to electromagnetically engage the magnetic brake band with the first north contact pole and a second south contact pole.

Preferably the controllable electrical current supply is supplied as a first positive direction current to the brake lock electromagnetic coil and a second negative direction current to the brake lock electromagnetic coil.

Preferably the tensioner includes a tensioner damping member, with the tensioner damping element member disposed between the tensioner moving member and the tensioner stationary member wherein the tensioner damping member dampens dynamic motion between the tensioner moving member and the tensioner stationary member.

Preferably the bias member comprises a spring, preferably disposed between the tensioner moving member and the tensioner stationary member, preferably a metal spring, preferably a metal wound spring, preferably a torsion spring or a clock spring.

Preferably the magnetic target band is coupled with the torque arm.

Preferably the EM coil is coupled with the tensioner stationary member.

Preferably when the controlled current is supplied, the magnetic target is drawn inward toward the EM coil, preferably with the magnetic target physically mechanically engaging the stationary interface of the tensioner stationary member, preferably the stationary EM coil lock poles, preferably with the magnetic target comprised of a magnetic brake band, preferably with the magnetic brake band wrapping around substantially an outer circumference of the tensioner stationary member, preferably with the magnetic brake band having at least one band end coupled with the torque arm tensioner moving member, preferably one anchored end connected and the distal other end of the band unanchored and free. Preferably the electromagnetic brake lock electromagnetic coil includes a electromagnetic core with a first north contact pole and a second south contact pole, and the electromagnetic brake lock magnetic target includes a magnetic brake band, wherein the controlled current is supplied to the brake lock electromagnetic coil to electromagnetically engage the magnetic brake band with the first north contact pole and a second south contact pole.

In an embodiment the invention includes a belt tensioner electromagnetic brake lock for controlling a tension of a belt with a controllable belt tension electrical current supply. The belt tensioner electromagnetic brake lock comprises a tensioner stationary member brake lock electromagnetic coil and a tensioner moving member brake lock magnetic rotating target, wherein a controlled current supplied to the tensioner stationary member brake lock electromagnetic coil inhibits the tensioner moving member brake lock magnetic rotating target from moving relative to the tensioner stationary member brake lock electromagnetic coil and controls the tension of the belt.

The belt tensioner electromagnetic brake lock preferably has a plurality of operation modes including at least a first operation mode and at least a second operation mode, and including a belt tensioner controller, the belt tensioner controller controlling a change from the at least first operation mode to the at least second operation mode, wherein the controlled current is supplied to the brake lock electromagnetic coil at least during the change from the at least first operation mode to the at least second operation mode to lock the movable member and contain the tension in the belt, preferably maintaining belt tension for an energy efficiency change of a machine vehicle preferably changing between energy efficiency modes.

Preferably the electromagnetic brake lock electromagnetic coil includes an electromagnetic core with a first north contact pole and a second south contact pole, and the electromagnetic brake lock magnetic target includes a magnetic brake band, wherein the controlled current is supplied to the brake lock electromagnetic coil to electromagnetically engage the magnetic brake band with the first north contact pole and a second south contact pole.

Preferably the controllable electrical current supply is supplied as a first positive direction current to the brake lock electromagnetic coil and a second negative direction current to the brake lock electromagnetic coil.

Preferably the brake lock includes a damping member, with the damping member disposed between the tensioner moving member and the tensioner stationary member. The damping member damping the dynamic motion between the tensioner moving member and the tensioner stationary member, preferably when no current is supplied to the EM coil. Preferably a bias member is included and comprises a spring, preferably disposed between the tensioner moving member and the tensioner stationary member, preferably a metal spring, preferably a metal wound spring such as torsion spring or a clock spring. Preferably the magnetic target band is coupled with the torque idler arm, with the magnetic target band rotating with the rotating housing with the unlocking state target gap between the rotating target band and the stationary EM coil. Preferably the EM coil is coupled with the tensioner stationary member, with the unlocking state target gap between the rotating target band and the stantionary EM coil, with the supplied current drawing the band inward and into physical contact and moving the target gap outward to between the now stationary target band and the rotation inhibited housing. Preferably when the controlled current is supplied, the magnetic target is drawn inward toward the EM coil, preferably with the magnetic target physically mechanically engaging an interface of the tensioner stationary member, preferably the EM coil lock poles, preferably with the magnetic target comprised of a magnetic brake band, preferably with the magnetic brake band wrapping around substantially an outer circumference of the tensioner stationary member. Preferably the magnetic brake band has at least one band end connected with the torque arm tensioner moving member housing, preferably with the one anchored end connected and the distal other end of the band unanchored and free. Preferably the electromagnetic brake lock electromagnetic coil includes an electromagnetic core with a first north contact pole and a second south contact pole, and the electromagnetic brake lock magnetic target includes a magnetic brake band, wherein the controlled current is supplied to the brake lock electromagnetic coil to electromagnetically engage the magnetic brake band with the first north contact pole and a second south contact pole.

In an embodiment the invention includes a method of controlling vehicle machine belt motion of a machine. The method includes providing a machine with a belt system with a belt.

The method includes providing a tensioner with a tensioner moving member which is movably supported relative to a tensioner stationary member; the tensioner including a rotating pulley belt engagement member which is rotatably supported on the tensioner moving member, the belt engagement member engaging the belt.

The method includes providing a bias member, the bias member biasing the belt engagement member into engagement with the belt tensioner pulley pressing the belt.

The method includes providing a controllable electrical current supply.

The method includes providing an electromagnetic brake lock, the electromagnetic brake lock including a brake lock electromagnetic coil and a brake lock magnetic target, the electromagnetic brake lock disposed between the tensioner moving member and the tensioner stationary member.

The method includes supplying a controlled current from the controllable electrical current supply to the brake lock electromagnetic coil to inhibit the tensioner moving member from moving relative to the tensioner stationary member.

Preferably the machine has a plurality of operation modes including at least a first operation mode and at least a second operation mode, and the machine includes a machine controller, the machine controller controlling a change from the at least first operation mode to the at least second operation mode, wherein the controlled current is supplied to the brake lock electromagnetic coil at least during the change from the at least first operation mode to the at least second operation mode to lock the movable member and contain the tension in the belt, preferably for an energy efficiency change of the vehicle, for maintaining tension during changes between energy efficiency modes and operations at different modes.

Preferably the method of controlling vehicle belt motion includes the machine with a plurality of operation modes with at least a first low fuel efficiency operation mode and at least a second high fuel efficiency operation mode, and the machine includes a machine controller, the machine controller controlling a change from the at least first low efficiency operation mode to the at least second high efficiency operation mode, wherein the controlled current is supplied to the brake lock electromagnetic coil at least during the change from the at least first low (fuel) efficiency operation mode to the at least second high (fuel) efficiency operation mode, preferably while the vehicle remains in the at least second high (fuel) efficiency operation mode to lock the movable member and contain the tension in the belt.

Preferably the tensioner used in a belt drive system for a multicylinder engine provided with a cylinder suspension controller which suspends the operation of some cylinders in the engine in operation, and the tensioner with a magnetic force controller which controls the magnetic force such that the magnetic force is applied to the target in response to a signal from the cylinder suspension controller which is given when the operation of the cylinders is suspended or the operation of the suspended cylinders is restarted by the cylinder suspension controller, operation of the multicylinder engine is shifted from a full cylinder operation mode in which all of the cylinders are working to a partial cylinder operation mode in which not less than one third thereof are suspended from working, the magnetic force is applied to the target in synchronization with the change in the number of the working cylinders.

Preferably the tensioner used in a belt drive system for an internal combustion engine combined with an electric alternator to generate electricity, preferably Belt Alternator Starter (BAS) system, with increased fuel economy by shutting off the engine when at an idle operating mode, and enabling early fuel cut-off during decelerations, and preferably with regenerative braking. Preferably the BAS system combines engine controls with a combined alternator/starter motor mounted with respect to the engine in an accessory drive position. Preferably the automotive accessory drive system includes a drive pulley connected to an output of the engine. Preferably a drive belt engages an engine output pulley, with the belt wrapped and engaging multiple driven pulleys. The flexible belt transmits forces between the output pulley and the driven pulleys. The driven pulleys are attached to vehicle devices such as a power steering units, air conditioning units, and pumps. Also preferably at least one driven pulley is an idler pulley which is used to assist the orientation, routing, and/or tensioning of the belt. Preferably the BAS system includes a combined starter/alternator motor mounted with respect to the other components of the beltdrive system, the BAS system starter/alternator motor restarts the engine, with the driven pulley linked with the engine's output shaft mounted drive pulley by the drive belt, the belt having a tension side and slack side while the engine is running. Preferably the tensioner is disposed to maintain tension on the slack side of the flexible drive belt. Preferably when a vehicle operation controller request controls a switching of operation mode to restart the engine, the driven pulley mounted to the combined alternator/starter motor will impart the rotational force to start the engine through the belt to the output shaft of the engine, with the normal slack side of the drive belt becoming the tension side during such BAS engine restart, and preferably to maintain the required frictional force between the flexible drive belt and the drive and driven pulleys during restart, the tensioner brake lock is locked to maintain the controlled belt tension.

Preferably the electromagnetic brake lock electromagnetic coil includes a electromagnetic core with a first (north) contact pole and a second (south) contact pole, and the electromagnetic brake lock magnetic target includes a magnetic brake band, wherein the controlled current is supplied to the brake lock electromagnetic coil to electromagnetically engage the magnetic brake band with the first (north) contact pole and a second (south) contact pole.

Preferably the controllable electrical current supply is controllable to supply a first positive direction current to the brake lock electromagnetic coil and a second negative direction current to the brake lock electromagnetic coil.

Preferably the tensioner includes a tensioner damping element member, with the tensioner damping element member disposed between the tensioner moving member and the tensioner stationary member, wherein the tensioner damping element member dampens dynamic motion between the tensioner moving member and the tensioner stationary member.

Preferably the bias member comprises a spring, preferably disposed between the tensioner moving member and the tensioner stationary member, preferably a metal spring, preferably a metal wound spring.

Preferably with the method the provided brake lock includes a damping member, with the damping member disposed between the tensioner moving member and the tensioner stationary member. The damping member damping the dynamic motion between the tensioner moving member and the tensioner stationary member, preferably when no current is supplied to the EM coil. Preferably a bias member is included and comprises a spring, preferably disposed between the tensioner moving member and the tensioner stationary member, preferably a metal spring, preferably a metal wound spring such as torsion spring or a clock spring. Preferably the magnetic target band is coupled with the torque idler arm, with the magnetic target band rotating with the rotating housing with the unlocking state target gap between the rotating target band and the stationary EM coil. Preferably the EM coil is coupled with the tensioner stationary member, with the unlocking state target gap between the rotating target band and the stationary EM coil, with the supplied current drawing the band inward and into physical contact and moving the target gap outward to between the now stationary target band and the rotation inhibited housing. Preferably when the controlled current is supplied, the magnetic target is drawn inward toward the EM coil, preferably with the magnetic target physically mechanically engaging an interface of the tensioner stationary member, preferably the EM coil lock poles, preferably with the magnetic target comprised of a magnetic brake band, preferably with the magnetic brake band wrapping around substantially an outer circumference of the tensioner stationary member. Preferably the magnetic brake band has at least one band end connected with the torque arm tensioner moving member housing, preferably with the one anchored end connected and the distal other end of the band unanchored and free. Preferably the electromagnetic brake lock electromagnetic coil includes a electromagnetic core with a first north contact pole and a second south contact pole, and the electromagnetic brake lock magnetic target includes a magnetic brake band, wherein the controlled current is supplied to the brake lock electromagnetic coil to electromagnetically engage the magnetic brake band with the first north contact pole and a second south contact pole.

In an embodiment the invention includes a method of making a belt tensioner for tensioning a belt with a controlled current from a controllable electrical current supply.

The method includes providing a tensioner moving member, the tensioner including a rotating pulley belt engagement member which is rotatably supported on the tensioner moving member, the belt engagement member for engaging the belt; providing tensioner stationary member.

The method includes movably supporting the tensioner moving member on the tensioner stationary member.

The method includes providing an electromagnetic brake lock, the electromagnetic brake lock including a brake lock electromagnetic coil and a brake lock magnetic target, the electromagnetic brake lock disposed between the tensioner moving member and the tensioner stationary member; wherein a controlled current from a controllable electrical current supply to the brake lock electromagnetic coil inhibits the tensioner moving member from moving relative to the tensioner stationary member.

Preferably the method includes providing a bias member, the bias member for biasing the belt engagement member into engagement with a belt with the tensioner pulley pressing the belt. Preferably the belt tensioner has a plurality of operation modes including at least a first operation mode and at least a second operation mode.

Preferably the electromagnetic brake lock electromagnetic coil includes an electromagnetic core with a first (north) contact pole and a second (south) contact pole, and the electromagnetic brake lock magnetic target includes a magnetic brake band, wherein the controlled current is supplied to the brake lock electromagnetic coil to electromagnetically engage the magnetic brake band with the first (north) contact pole and a second (south) contact pole.

Preferably the controllable electrical current supply is controllable to supply a first positive direction current to the brake lock electromagnetic coil and a second negative direction current to the brake lock electromagnetic coil.

Preferably the tensioner includes a tensioner damping element member, with the tensioner damping element member disposed between the tensioner moving member and the tensioner stationary member (wherein the tensioner damping element member dampens dynamic motion between the tensioner moving member and the tensioner stationary member).

Preferably the bias member comprises a spring. Preferably with the method the provided brake lock includes a damping member, with the damping member disposed between the tensioner moving member and the tensioner stationary member. The damping member damping the dynamic motion between the tensioner moving member and the tensioner stationary member, preferably when no current is supplied to the EM coil. Preferably a bias member is included and comprises a spring, preferably disposed between the tensioner moving member and the tensioner stationary member, preferably a metal spring, preferably a metal wound spring such as torsion spring or a clock spring. Preferably the magnetic target band is coupled with the torque idler arm, with the magnetic target band rotating with the rotating housing with the unlocking state target gap between the rotating target band and the stationary EM coil. Preferably the EM coil is coupled with the tensioner stationary member, with the unlocking state target gap between the rotating target band and the stationary EM coil, with the supplied current drawing the band inward and into physical contact and moving the target gap outward to between the now stationary target band and the rotation inhibited housing. Preferably when the controlled current is supplied, the magnetic target is drawn inward toward the EM coil, preferably with the magnetic target physically mechanically engaging an interface of the tensioner stationary member, preferably the EM coil lock poles, preferably with the magnetic target comprised of a magnetic brake band, preferably with the magnetic brake band wrapping around substantially an outer circumference of the tensioner stationary member. Preferably the magnetic brake band has at least one band end connected with the torque arm tensioner moving member housing, preferably with the one anchored end connected and the distal other end of the band unanchored and free. Preferably the electromagnetic brake lock electromagnetic coil includes an electromagnetic core with a first north contact pole and a second south contact pole, and the electromagnetic brake lock magnetic target includes a magnetic brake band, wherein the controlled current is supplied to the brake lock electromagnetic coil to electromagnetically engage the magnetic brake band with the first north contact pole and a second south contact pole.

In an embodiment the invention includes a machine. The machine including a belt system with a belt.

The machine belt system including a tensioner with a tensioner moving member which is movably supported on a tensioner stationary member; a tensioner idler pulley which is rotatably supported on the tensioner moving member and which a portion of the belt is engaged. The machine belt system including a bias member, the bias member biasing the tensioner moving member with the tensioner idler pulley pressing the belt to maintain a desired tension.

The machine belt system including a controllable electrical current supply.

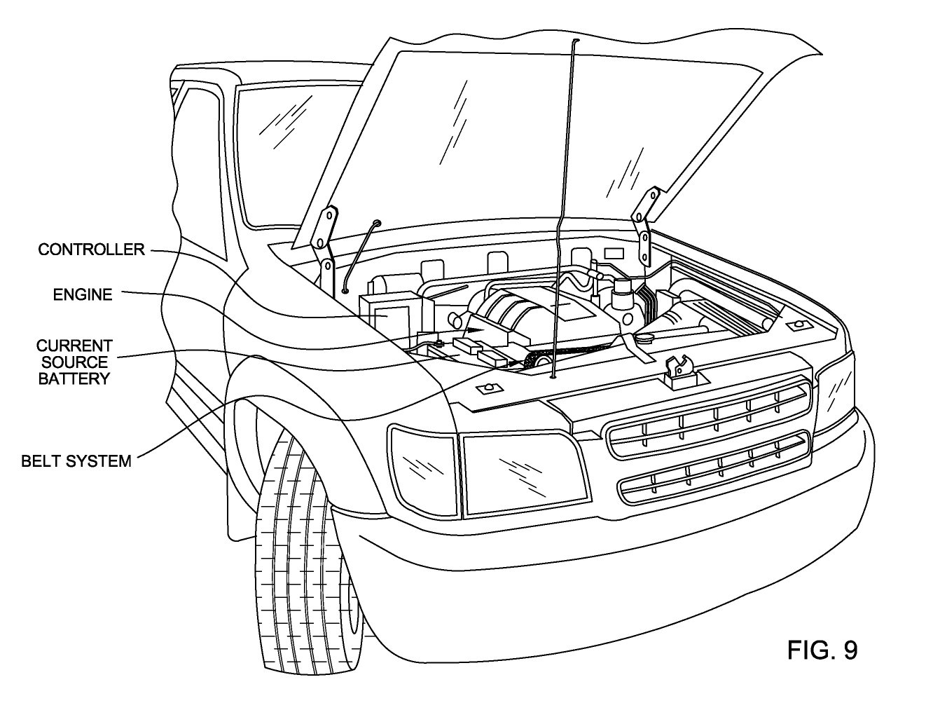

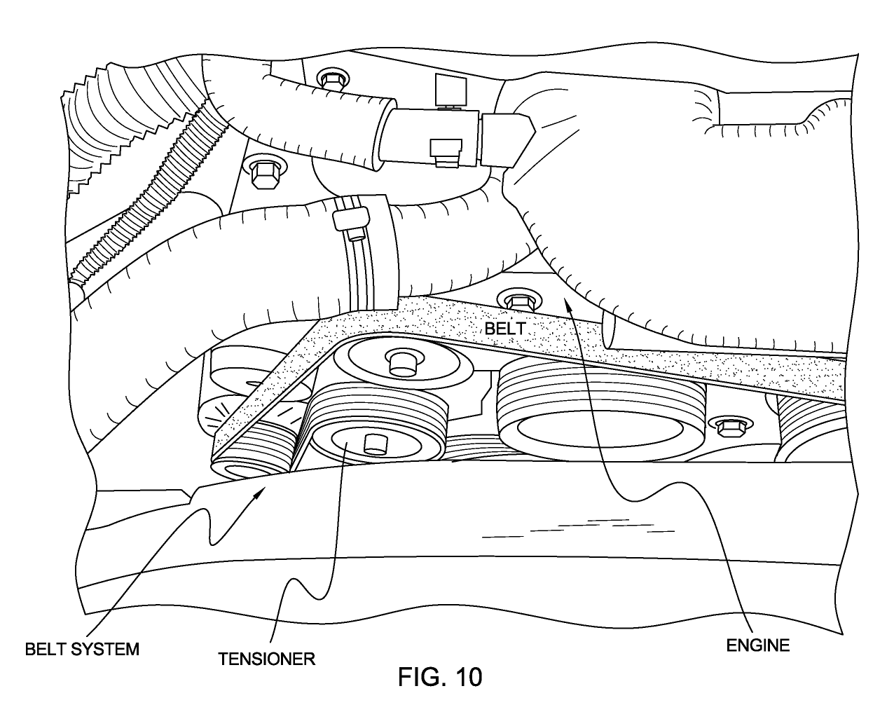

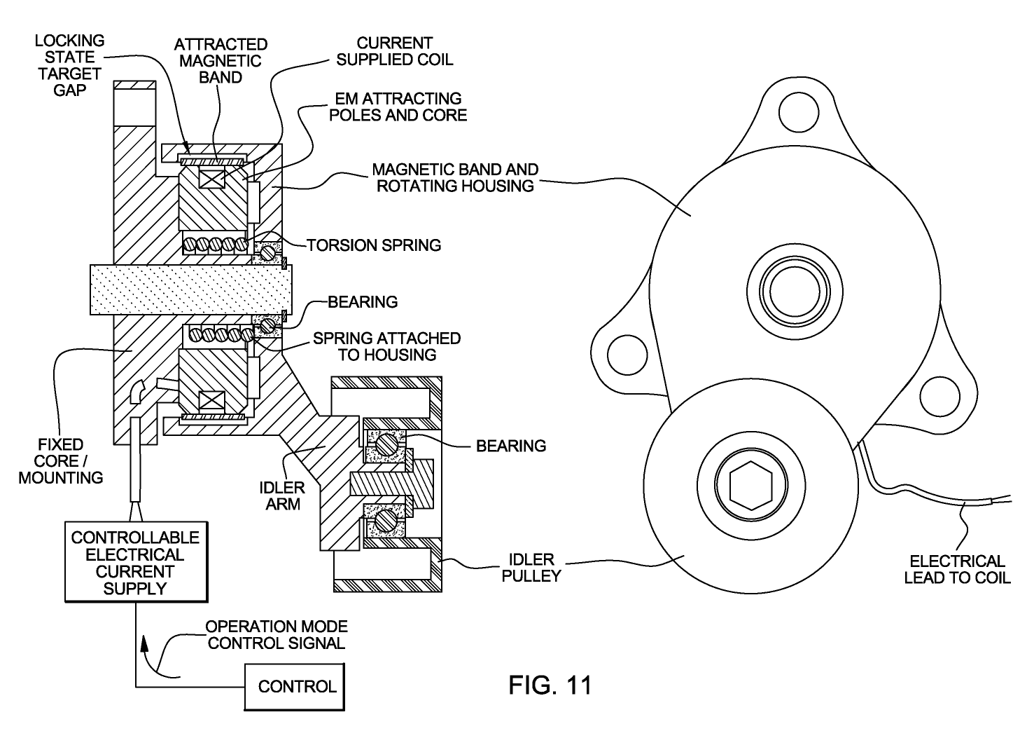

FIG. 9 illustrates an embodiment of the invention. In an embodiment the invention includes a vehicle machine with an engine and belt system with the tensioner. As shown in FIG. 10 the vehicle includes an engine and a belt system with a belt. The belt system includes the tensioner with the tensioner moving member which is movably supported on a tensioner stationary member. The tensioner preferably includes the tensioner rotating engagement member pulley which is rotatably supported on the tensioner moving member and around which at least a portion of the belt is engaged. The vehicle belt system preferably includes a bias member, the bias member biasing the tensioner moving member with the tensioner pulley pressing the belt to maintain a preferred tension in the belt. The vehicle belt system includes the controllable electrical current supply. The vehicle belt system includes the electromagnetic brake lock, the electromagnetic brake lock includes the brake lock electromagnetic coil and the brake lock magnetic target, the electromagnetic brake lock disposed between the tensioner moving member and the tensioner stationary member wherein the controlled current supplied from the controllable electrical current supply to the brake lock electromagnetic coil inhibits the tensioner moving member from moving relative to the tensioner stationary member. As illustrated in FIG. 11, the supplied current electromagnetically attracts and draws the rotating housing band inward into contact with the fixed stationary member removing the gap therebetween to inhibit the moving member from moving relative to the tensioner stationary member to maintain the desired belt tension.

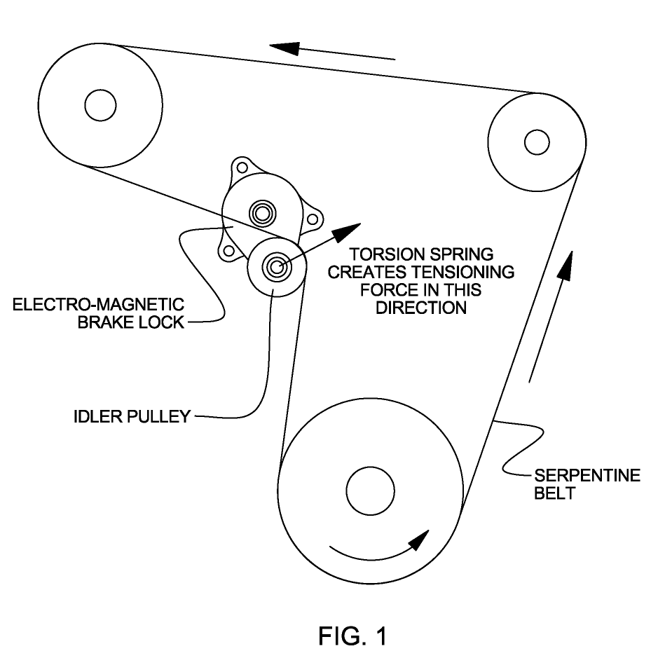

An electromagnetic brake lock is preferably utilized in an automotive vehicle machine belt tensioner. Preferably a bias member, preferably a spring, such as a torsional spring acts to provide the normal tension in the flexible serpentine belt. Preferably the idler pulley on the end of the tensioner moving member torsion arm biased by the spring moves to accommodate any stretch and slack that might occur in the belt over time and normal dynamic motion of the belt and operation of the vehicle machine. Preferably friction in the system provides damping to control this motion under normal conditions. The electromagnetic brake lock is added so that under certain transient conditions the reaction force of the idler pulley against the belt can be dramatically increased to prevent belt slippage and squealing as indicted in FIG. 1. When engaged, the electromagnetic brake lock band-brake prevents the idler pulley and belt from moving in the direction opposite to that of the blue arrow in FIG. 1 emanating from the center of the idler pulley. It helps prevent transient forces in the belt from overcoming the spring tension and causing the belt to slacken and slip.

When the electromagnetic brake lock brake is engaged the device provides a reactive torque to maintain the position of the idler arm and maintain tension in the belt.

The amount of torque required of the electromagnetic brake lock brake is large. For preferred embodiments of the invention the torques are provided for automotive engine belt systems with the electromagnetic brake lock band-brake is preferably on the order of about 75-80 mm in diameter. In preferred embodiments the electromagnetic brake lock band-brake diameter is at least 40 mm, preferably at least 55 mm, preferably at least 66 mm, and most preferably at least 69 mm. In preferred embodiments the electromagnetic brake lock band-brake diameter is less than 200 mm, preferably less than 151 mm, preferably less than 133 mm, and most preferably less than 111 mm. In preferred embodiments the electromagnetic brake lock band-brake diameter is in the range from 40 mm to 200 mm, more preferably 55 mm to 151 mm, and more preferably 66 mm to 133 mm, and most preferably 69 mm to 111 mm.

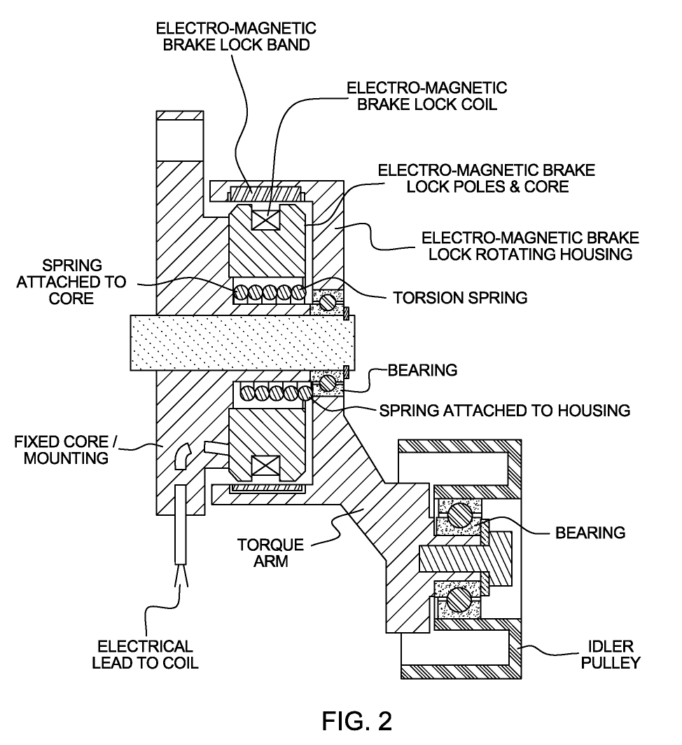

Details of an embodiment of the electromagnetic brake lock controlled tensioning device are shown in FIG. 2. In this embodiment a bias member torsion spring provides the off-state torque to the idler arm. The electromagnetic brake lock band brake is preferably located outboard of the torsion spring. Preferably one end of the electromagnetic brake lock band is attached to the rotating electromagnetic brake lock housing that is attached to the idler arm. The other end of the electromagnetic brake lock band is free. The torsion spring acts between the tensioner stationary core member and the tensioner rotating housing moving member.

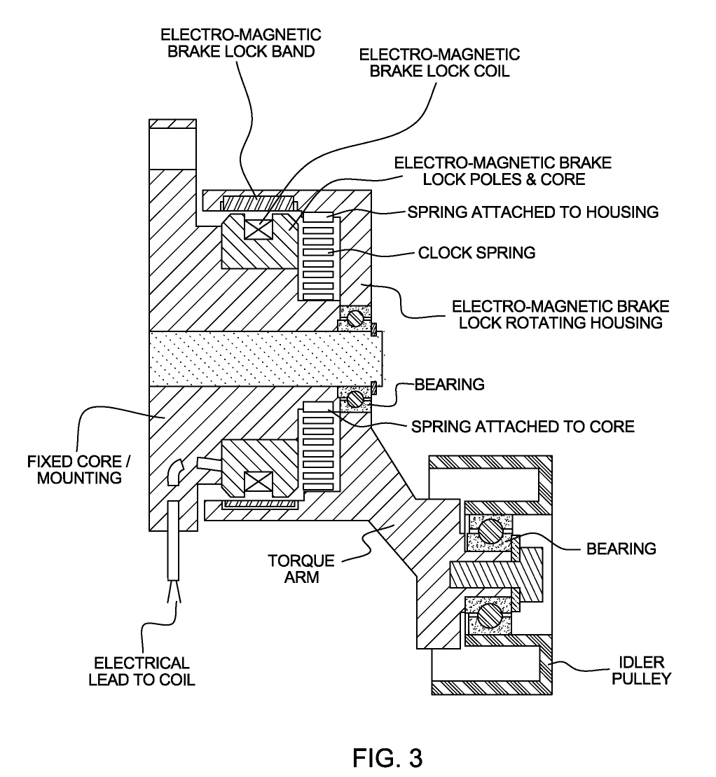

A second embodiment is shown in FIG. 3. In this embodiment the off-state torque is provided by a heavy clock spring that is mounted adjacent to the electromagnetic brake lock brake.

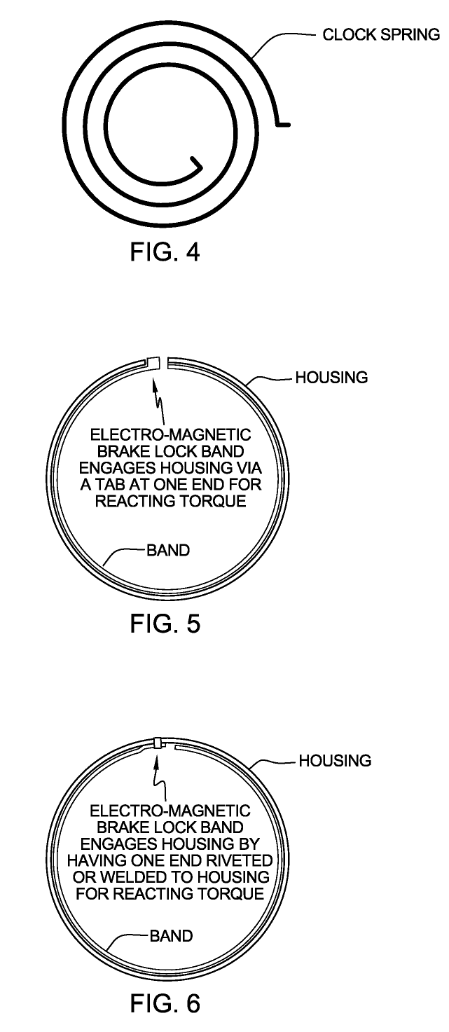

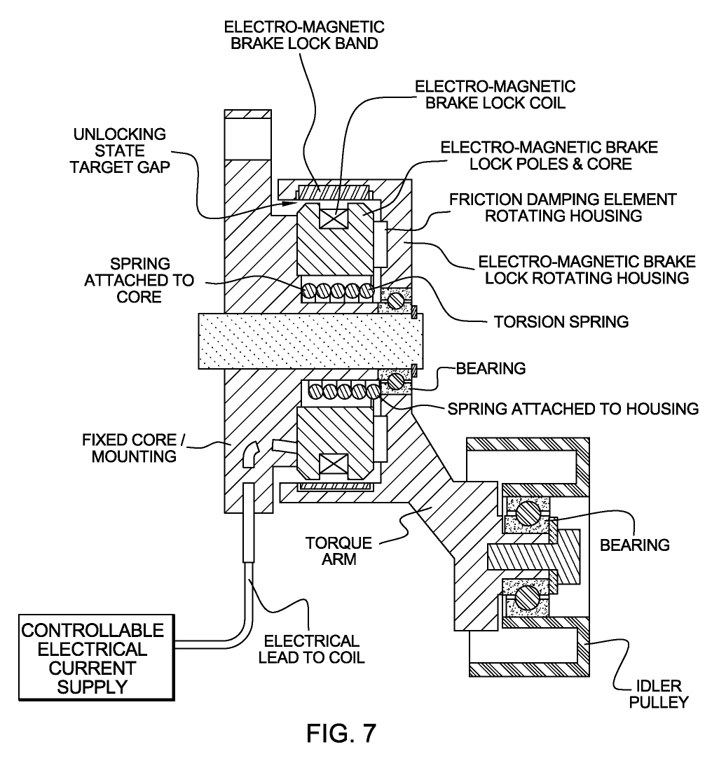

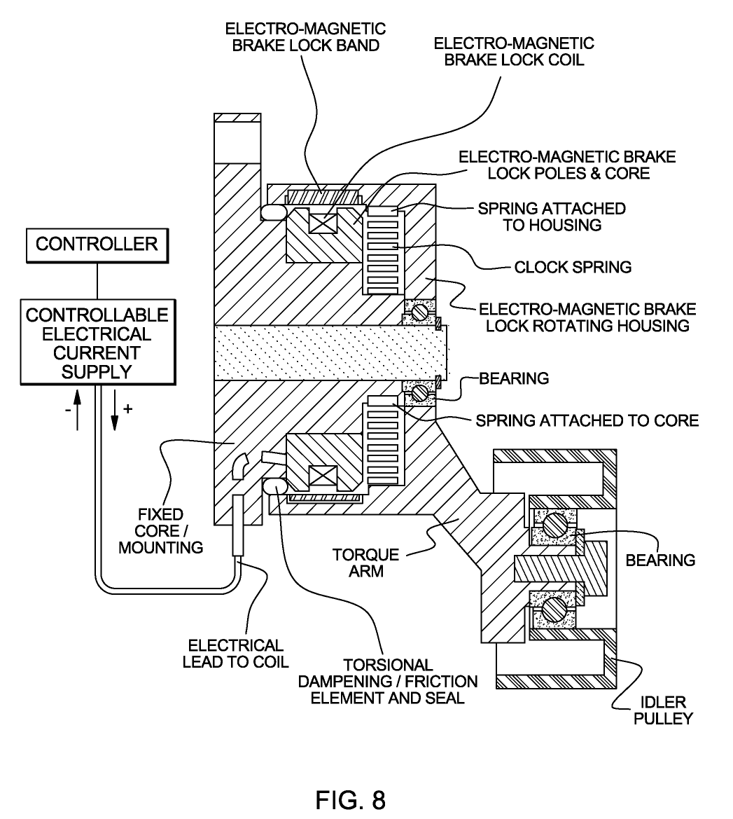

A detail of a clock spring are shown is shown in FIG. 4 as is would be oriented in the front (right) view in FIG. 3 so as to provide torque in the proper direction per FIG. 1.

Embodiments on how the electromagnetic brake lock band are attached to the rotating housing are shown in FIGS. 5 and 6. In FIG. 5 the band is attached by a tab that engages a slot in the housing. In FIG. 6 an embodiment is shown wherein the end of the band is more permanently attached to the housing with an anchor attachment fixture such as a rivet, weld, or screw.

Preferably the electromagnetic brake lock is a dry brake lock. Preferably the electromagnetic brake lock is a fluid liquid free electromagnetic brake lock. Preferably the electromagnetic brake lock is free of controllable fluid, preferably free of ER electrorheological fluid and MR magnetorheological fluid. Preferably the electromagnetic brake lock is a substantially fluid free brake lock, with a dry solid magnetic material target, preferably a nonparticulate solid, preferably with the band comprised of a solid metal member piece, preferably a metal band shaped to encircle the interior stationary EM coil and contact poles it surrounds.

The machine belt system including an electromagnetic means for locking the tensioner moving member with the tensioner stationary member wherein a controlled current supplied from the controllable electrical current supply to the electromagnetic means inhibits the tensioner moving member from moving relative to the tensioner stationary member and maintains the desired tension.

It will be apparent to those skilled in the art that various modifications and variations can be made to the invention without departing from the spirit and scope of the invention. Thus, it is intended that the invention cover the modifications and variations of this invention provided they come within the scope of the appended claims and their equivalents. It is intended that the scope of differing terms or phrases in the claims may be fulfilled by the same or different structure(s) or step(s).

What is claimed is:

1. A vehicle, said vehicle comprised of an engine and a belt system with a belt,
said belt system including a tensioner with a tensioner moving member which is movably supported on a tensioner stationary member; a tensioner pulley which is rotatably supported on said tensioner moving member and around which at least a portion of said belt is engaged;
a bias member, said bias member biasing the tensioner moving member with the tensioner pulley pressing said belt;
a controllable electrical current supply;
an electromagnetic brake lock, said electromagnetic brake lock including a brake lock electromagnetic coil and a brake lock magnetic target, said electromagnetic brake lock disposed between said tensioner moving member and said tensioner stationary member wherein a controlled current supplied from said controllable electrical current supply to said brake lock electromagnetic coil inhibits said tensioner moving member from moving relative to said tensioner stationary member.

2. A vehicle as claimed in claim 1, wherein said vehicle has a plurality of operation modes including at least a first operation mode and at least a second operation mode, and said vehicle includes a controller, said controller controlling a change from said at least first operation mode to said at least second operation mode, wherein said controlled current is supplied to said brake lock electromagnetic coil at least during said change from said at least first operation mode to said at least second operation mode.

3. A vehicle as claimed in claim 1, wherein said vehicle has a plurality of operation modes including at least a first low efficiency operation mode and at least a second high efficiency operation mode, and said vehicle includes a controller, said controller controlling a change from said at least first low efficiency operation mode to said at least second high efficiency operation mode, wherein said controlled current is supplied to said brake lock electromagnetic coil at least during said change from said at least first low efficiency operation mode to said at least second high efficiency operation mode.

4. A vehicle as claimed in claim 1, wherein said electromagnetic brake lock electromagnetic coil includes a electromagnetic core with a first contact pole and a second contact pole, and said electromagnetic brake lock magnetic target includes a magnetic brake band, wherein said controlled current is supplied to said brake lock electromagnetic coil to electromagnetically engage said magnetic brake band with said first contact pole and a second contact pole.

5. A vehicle as claimed in claim 1, wherein said controllable electrical current supply is controllable to supply a first positive direction current to said brake lock electromagnetic coil and a second negative direction current to said brake lock electromagnetic coil.

6. A vehicle as claimed in claim 1, wherein said tensioner includes a tensioner damping member, with said tensioner damping member disposed between said tensioner moving member and said tensioner stationary member.

7. A vehicle as claimed in claim 1, wherein said bias member comprises a spring.

8. A belt tensioner for a belt, said belt tensioner comprising a tensioner moving member movably supported on a tensioner stationary member; a tensioner pulley which is rotatably supported on said tensioner moving member, said tensioner pulley for engaging said belt, a bias member, said bias member biasing the tensioner moving member with the biased tensioner moving member tensioner pulley pressing said belt;
an electromagnetic brake lock, said electromagnetic brake lock including a brake lock electromagnetic coil and a brake lock magnetic target, said electromagnetic brake lock disposed between said tensioner moving member and said tensioner stationary member wherein a controlled current supplied to said brake lock electromagnetic coil inhibits said tensioner moving member from moving relative to said tensioner stationary member.

9. A belt tensioner as claimed in claim 8 wherein said tensioner moving member rotates relative to said tensioner stationary member, with said brake lock magnetic target coupled with said tensioner moving member with said brake lock magnetic target rotating relative to said tensioner stationary member when said controlled current is not supplied.

10. A belt tensioner as claimed in claim 8 having a plurality of operation modes including at least a first operation mode and at least a second operation mode, and including a belt tensioner controller, said belt tensioner controller controlling a change from said at least first operation mode to said at least second operation mode, wherein said controlled current is supplied to said brake lock electromagnetic coil at least during said change from said at least first operation mode to said at least second operation mode.

11. A belt tensioner as claimed in claim 10 wherein said operation modes including at least a first low efficiency operation mode and at least a second high efficiency operation mode.

12. A belt tensioner as claimed in claim 8 wherein said electromagnetic brake lock electromagnetic coil includes a electromagnetic core with a first contact pole and a second contact pole, and said electromagnetic brake lock magnetic target includes a magnetic brake band, wherein said controlled current is supplied to said brake lock electromagnetic coil to electromagnetically engage said magnetic brake band with said first contact pole and a second contact pole.

13. A belt tensioner as claimed in claim 8, wherein said controllable electrical current supply is supplied as a first positive direction current to said brake lock electromagnetic coil and a second negative direction current to said brake lock electromagnetic coil.

14. A belt tensioner as claimed in claim 8 wherein said tensioner includes a tensioner damping element member, with said tensioner damping element member disposed between said tensioner moving member and said tensioner stationary member.

15. A belt tensioner as claimed in claim 8 wherein said bias member comprises a spring.

16. A belt tensioner electromagnetic brake lock for controlling a tension of a belt with a controllable belt tension electrical current supply,
said belt tensioner electromagnetic brake lock comprising, a tensioner stationary member brake lock electromagnetic coil and a tensioner moving member brake lock magnetic rotating target, wherein a controlled current supplied to said tensioner stationary member brake lock electromagnetic coil inhibits said tensioner moving member brake lock magnetic rotating target from moving relative to said tensioner stationary member brake lock electromagnetic coil and controls said tension of said belt.

17. A belt tensioner electromagnetic brake lock as claimed in claim 16 having a plurality of operation modes including at least a first operation mode and at least a second operation mode, and including a belt tensioner controller, said belt tensioner controller controlling a change from said at least first operation mode to said at least second operation mode, wherein said controlled current is supplied to said brake lock electromagnetic coil at least during said change from said at least first operation mode to said at least second operation mode.

18. A belt tensioner electromagnetic brake lock as claimed in claim 16 wherein said electromagnetic brake lock electromagnetic coil includes a electromagnetic core with a first contact pole and a second contact pole, and said electromagnetic brake lock magnetic target includes a magnetic brake band, wherein said controlled current is supplied to said brake lock electromagnetic coil to electromagnetically engage said magnetic brake band with said first contact pole and a second contact pole.

19. A belt tensioner electromagnetic brake lock as claimed in claim 16 wherein said controllable electrical current supply is supplied as a first positive direction current to said brake lock electromagnetic coil and a second negative direction current to said brake lock electromagnetic coil.

20. A method of controlling motion of a machine, said method including:
providing a machine with a belt system with a belt,
providing a tensioner with a tensioner moving member which is movably supported relative to a tensioner stationary member; said tensioner including a belt engagement member which is supported on said tensioner moving member, said belt engagement member engaging said belt;
providing a bias member, said bias member biasing said belt engagement member into engagement with said belt;
providing a controllable electrical current supply;
providing an electromagnetic brake lock, said electromagnetic brake lock including a brake lock electromagnetic coil and a brake lock magnetic target, said electromagnetic brake lock disposed between said tensioner moving member and said tensioner stationary member;
supplying a controlled current from said controllable electrical current supply to said brake lock electromagnetic coil to inhibit said tensioner moving member from moving relative to said tensioner stationary member.

21. A method of controlling motion as claimed in claim 20, wherein said machine has a plurality of operation modes including at least a first operation mode and at least a second operation mode, and said machine includes a machine controller, said machine controller controlling a change from said at least first operation mode to said at least second operation mode, wherein said controlled current is supplied to said brake lock electromagnetic coil at least during said change from said at least first operation mode to said at least second operation mode.

22. A method of controlling motion as claimed in claim 20, wherein said machine has a plurality of operation modes including at least a first low efficiency operation mode and at least a second high efficiency operation mode, and said machine includes a machine controller, said machine controller controlling a change from said at least first low efficiency operation mode to said at least second high efficiency operation mode, wherein said controlled current is supplied to said brake lock electromagnetic coil at least during said change from said at least first low efficiency operation mode to said at least second high efficiency operation mode.

23. A method of controlling motion as claimed in claim 20, wherein said electromagnetic brake lock electromagnetic coil includes a electromagnetic core with a first contact pole and a second contact pole, and said electromagnetic brake lock magnetic target includes a magnetic brake band, wherein said controlled current is supplied to said brake lock electromagnetic coil to electromagnetically engage said magnetic brake band with said first contact pole and a second contact pole.

24. A method of controlling motion as claimed in claim 20, wherein said controllable electrical current supply is controllable to supply a first positive direction current to said brake lock electromagnetic coil and a second negative direction current to said brake lock electromagnetic coil.

25. A method of controlling motion as claimed in claim 20, wherein said tensioner includes a tensioner damping element member, with said tensioner damping element member disposed between said tensioner moving member and said tensioner stationary member.

26. A method of controlling motion as claimed in claim 20, wherein said bias member comprises a spring.

27. A method of making a belt tensioner for tensioning a belt with a controlled current from a controllable electrical current supply, said method including:
providing a tensioner moving member, said tensioner including a belt engagement member which is supported on said tensioner moving member, said belt engagement member for engaging said belt;
providing tensioner stationary member;
movably supporting said tensioner moving member on said tensioner stationary member;
providing an electromagnetic brake lock, said electromagnetic brake lock including a brake lock electromagnetic coil and a brake lock magnetic target, said electromagnetic brake lock disposed between said tensioner moving member and said tensioner stationary member; wherein a controlled current from a controllable electrical current supply to said brake lock electromagnetic coil inhibits said tensioner moving member from moving relative to said tensioner stationary member.

28. A method of making a belt tensioner as claimed in claim 27 including providing a bias member, said bias member for biasing said belt engagement member into engagement with a belt.

29. A method of making a belt tensioner as claimed in claim 27 wherein said belt tensioner has a plurality of operation modes including at least a first operation mode and at least a second operation mode.

30. A method of making a belt tensioner as claimed in claim 27 wherein said electromagnetic brake lock electromagnetic coil includes a electromagnetic core with a first contact pole and a second contact pole, and said electromagnetic brake lock magnetic target includes a magnetic brake band, wherein said controlled current is supplied to said brake lock electromagnetic coil to electromagnetically engage said magnetic brake band with said first contact pole and a second contact pole.

31. A method of making a belt tensioner as claimed in claim 27 wherein said controllable electrical current supply is controllable to supply a first positive direction current to said brake lock electromagnetic coil and a second negative direction current to said brake lock electromagnetic coil.

32. A method of making a belt tensioner as claimed in claim 27 wherein said tensioner includes a tensioner damping element member, with said tensioner damping element member disposed between said tensioner moving member and said tensioner stationary member.

33. A method of making a belt tensioner as claimed in claim 28 wherein said bias member comprises a spring.

34. A machine, said machine including a belt system with a belt,
said belt system including a tensioner with a tensioner moving member which is movably supported on a tensioner stationary member; a tensioner idler pulley which is rotatably supported on said tensioner moving member and which a portion of said belt is engaged;
a bias member, said bias member biasing the tensioner moving member with the tensioner idler pulley pressing said belt to maintain a desired tension;
a controllable electrical current supply;
an electromagnetic means for locking said tensioner moving member with said tensioner stationary member wherein a controlled current supplied from said controllable electrical current supply to said electromagnetic means inhibits said tensioner moving member from moving relative to said tensioner stationary member and maintains said desired tension.
